(19) United States
(12) Patent Application Publication
(10) Pub. No.: US 2008/0145127 A1
(43) Pub. Date: Jun. 19, 2008

(54) Book-shaped, back-typing, ergonomic computer keyboard

(76) Inventor: Hang Yu Liu, Beijing (CN)

Correspondence Address: Mr. Liu Hang Yu, Rm.1908, Bldg. 2, No. 9, Zi Fang Rd., Chao Yang Dist., Beijing, 100021, omitted

(21) Appl. No.: 11/544,573

(22) Filed: Oct. 10, 2006

(51) Int. Cl. B41J 5/00

(52) U.S. Cl. 400/489

(57) ABSTRACT

A stand-alone, book-shaped compact size ergonomic computer keyboard is introduced in the invention. All the alphabetic, number and symbol keys are placed on the back side of the keyboard that are off sight of the operator, The positions of the keys are illustrated by print of key indicia in the front side of the keyboard so the operator can locate the keys. The layout of the keys is suitable for touch typing from the back side but still keeps most of the fingering of QWERTY layout. The F1 to F12 keys, arrow keys and page control keys are placed on the upper part of the front side of keyboard to be operated by thumbs. The ‘Space’, ‘Backspace,’ ‘Return’, ‘Shift’, ‘Ctrl’, ‘Alt’, ‘Caps lock’, ‘Tab’, ‘Fn’, ‘Esc’ and ‘Delete’ keys can be allocated onto four predefined key zones on the keyboard surface in different arrays and combinations. A cursor tracking device (mouse) is also integrated in the keyboard. During touch typing, the keyboard is hold lightly in operators' hands and stands on operator's lap or abdomen or on a table with the key indicia facing to the operator. The operator is free to sit, couch or even lie down on his back while typing.

### BACKGROUD OF THE INVENTION

1. Field of Invention

This invention relates to computer keyboard, particularly to ergonomically designed keyboard and data input device used with various electronic equipments.

2. Review of Prior Arts

Driving by the ever prevalent use of computer, computer keyboard has now become the most common tool in offices, homes and public places for purpose of work, entertainment, travel and various usages. Following Moore's Law, computer is getting more and more compact while getting more powerful. With the new developments in LCD, LPD and projector technologies, the size of the display screen also gets larger. However, keyboard, while indispensable, the most important human-computer interface has become a modern antic. The currently most used keyboard layout is inherited from QWERTY typewriter that was invented in 1886 by Christopher Sholes. The basic design of and shape of keyboard, especially the layout and the way of touch typing keep unchanged for more than a hundred and twenty years.

Dvorak (U.S. Pat. No. 2,040,248, Dvorak et. al. May 12, 1936) developed a new key layout in an attempt to reduce the finger movements on the keyboard during touch typing, so far DVORAK keyboard it is the only alternative keyboard that seen some application. There had been other inventions targeting at improve the efficiency or typing speed of the keyboard (U.S. Pat. No. 4,332,493 Einbinder June 1, 1982). Some other keyboards give out layouts that are easier to be remembered (U.S. Pat. No. 4,963,044 Warner, Oct. 16, 1990). However, very limited people are willing to adapt to a new keyboard layout. A strong habitual inclination in people makes them stick to the standard QWERTY keyboard.

It is now known to most people that the ever serious problem associated with using the QWERTY keyboard is that long time typing job can cause Repetitive Motion Injuries (RMI) such as Carpal Tunnel Syndrome (CTS). Many studies show that pronation of the hands or abduction of the elbows would cause stress and arouse problems on waists, shoulders, back and neck. Spencer, (U.S. Pat. No. 5,137,384, Aug. 11, 1992) introduced an ergonomic keyboard to relief such problems, the keyboard is spited into two vertical halves, the invention allows the operator's hands and arms to be maintained in a substantially relaxed, natural position. Mirrors are place on both part of the keyboard to reflect the key positions.

More efforts was given to solve the CTS/RMI problems through out the past years, Ergonomic keyboard of various shapes like curved mound (U.S. Pat. No. 6,132,118 Grezeszak Oct. 17, 2000), pyramid shaped (U.S. Pat. No. 5,426,449 Danziger 1995) and side mounted (U.S. Pat. No. 5,160,919 Mohler, et al. Nov. 3, 1992) were invented to change the position of hands as well as the way of typing to alleviates the problems.

Data entry system with ergonomic base including upper surface controls and side surface controls was invented by Willner, et al. (U.S. Pat. No. 5,874,906 Feb. 23, 1999). The invention takes the shape of a joystick with two hand grip portions. Together with combination of upper surface and side surface keys, mode select are used to generate key signals. The keyboard is different from the standard keyboard both in shape and in the key sets. Goodenough and Gary Lee (U.S. Pat. No. 6,939,066, Sep. 6, 2005) suggested a handle structured keyboard with front and back key functionality. A software algorithm is provided to aid the user to locate the keys in the back of the keyboard that are not visible to the operator.

For all the introduced different keyboards, so far we haven't seen them widely used. The author concludes here some of item might be the reasons and also suggested certain aspect that can be improved even for a standard keyboard.
1. The most of the efforts to replace the QWERTY keyboard layout are proved to be failure. The previous invention have tried many ways to introduce new layout, but full abandonment the QWERTY keyboard is difficult to be accepted by most of the people that already established the habit of using standard keyboard and customized to the fingering.
2. Compared to the stand keyboard, various shape of keyboard seems too complicated and whimsical to the users. The shape and size of the keyboard, the space to accommodate keyboard and the portability of the keyboard have always the user's choice. The user needs a simple and common tool that easy to be used and carried around.
3. Keyboard with split keypad haven't been widely accepted is probably due to it is mind distracting when typing in separate key pad simultaneously. One can easily feel the loss of focus when two hands placed apart typing. The split keyboard is also relatively difficult to be placed, deployed and packed than a standard keyboard.
4. For most of the users, keys positions need to be visible because they don't remember all the key positions on the keyboard, and even they do, their eyes would need to check the keys from time to time. For some of the invented keyboard, the keys position cannot be seen, or can hardly be seen. Especially the keyboards with keypad facing to right and left side.
5. The visibility of the key positions is not good even on a standard keyboard because the key indicia on a standard keyboard are not facing directly to operator's eyes but facing upward to the roof. Moreover, the operating hands are blocking eyesight of the operator. It is also difficult for the operator to locate the less remembered digital and symbol keys that lined on the far edge of the standard keyboard.
6. Round keys, triangle keys and keys of various shapes on a computer keyboard are space consuming and difficult to form an efficient layout, we have seen many invention looks like a button penal in an old space ship. The author believes that a keyboard uses mostly the adjacent rectangular keys would be suitable for an efficient and compact keyboard.
7. In a computer keyboard, the total number of keys is over 70, it is not possible to cover all of them only by finger movements without hands move to different locations. In fact, in a standard computer keyboard, hands moves a lot out of the ‘home position’ to reach keys like arrow keys or page control keys. Many previous inventions tend to gives hands one fixed ‘home’ position or one holding position. Which means hand movements out of the ‘home’ position is very much limited and only finger movements are allowed to finish the touch typing. This will lead to too crowded key space and too small key size, or the other way, keys are assigned with too many functions.

### SUMMARY OF THE INVENTION

Inspired by musical instruments like guitar, cello, accordion, hand drum and the ways musicians playing them, the author believes that a new type of keyboard that can be hold vertically with two hands touch typing on the back side of it would be natural and viable by human ergonomics. The challenge is people can not see the keys. A good way to deal with it is to let the operator see the key positions by adding key indicia on the front side that are facing to the operator. Now the basic ideas are established for the invention. The following listed are objectives needs to be further implemented and also some application projections of the invention.

To be clear, ‘front side’ means the keyboard surface that is facing the operator; ‘back side’ means the keyboard surface that is off sight of the operator. We also refer the generic computer QWERTY keyboard as ‘standard keyboard’ in contrast with the invention herein.
1. One of the most important objectives is to preserve as much as possible the characteristics of the QWERTY layout. On the keyboard invented herein, the member of keys and key sequence in each row, the position shifts between the key rows are mostly preserved the same as those on the QWERTY keyboard so as to keep the same typing fingering. This would largely save the operator from learning new layout and new key positions.
2. Visibility of keys became a major consideration. The invention herein uses key indicia on the front side since the keys are placed on the back side of the keyboard that is out of sight of the operator. By doing this, the invention gives even better visibility of the key positions than the standard keyboard due to:
   a. The keyboard body is erected so the key indicia are now facing directly to the operators eyesight.
   b. The hands are typing on the back of the keyboard thus there is no blocking of eyesight from the key indicia.
   c. As a ‘side effect’, the number and symbol keys indicia are now located in the middle of a key indicia area, so they are now looks much clearer to the operators than they are on a standard keyboard.
3. Compact in size and good in shape are very important objectives. The invented keyboard and its keys are designed with a simple and normal shape. Rectangular keys and book-shaped body are chosen to construct a simple and compact structure. The invented keyboard fully utilizes the surfaces of the keyboard and the keys are arranged in a more compact layout. With the same key size as that on a standard keyboard, the dimension of the invented book-shaped keyboard is around B5 paper size; if uses smaller rectangular keys, the keyboard dimension further reduces to A5 size or even smaller. It is easy to be packed, to put in a hand bag and to be carried around.
4. On the standard QWERTY keyboard, ‘F’ and ‘J’ keys are the ‘home positions’ of the index fingers for both hands. The invent keyboard herein also use the same home positions. The ‘F’ and ‘J’ keys are aligned on the book-shaped keyboard so the home position of right and heft hand are also aligned. The keyboard allows the hands to move out of the home position to type certain keys as well as operating the integrated mouse. Thumb finger and index finger are more used due to extended key area are applied. This further reduces the work of the small fingers.
5. The invented keyboard provides the possibility for operator to type comfortably when sits before desk, couch on sofa, or even lie on bed. The key indicia are facing to the eyesight of the operator even with operator lies flat with head adequately pillowed. The new invention might not solve all CTS/RMI problems. However, in contrast to standard keyboard, the invention can provide a change of positioning for shoulders, arms and hands. It allows the operator's hands and arms to maintain a substantially relaxed, natural position i.e. arms keeps a relaxed position by the operator's side, with hands holding the keyboard lightly, palm facing each other and finger bending naturally inwards towards the operator; And It allows relaxed back-lying position during typing therefore further gives relief for back/neck problems caused by strict sitting work conditions.
6. On the other hand, the application of large LCD and LPD screens and projectors requires the operator to stay more apart from the large screen. More over, in many cases, put keyboard on a table might be awkward and unnecessary. A keyboard that is more compact and easy to be operated without table is much more practical. The invention herein provides possibilities to type ‘off table’ comfortably.
7. Reports show that the keyboard might be the dirtiest device in the world. Exposed to the daily dust, sweat and grease of hands, the keyboard becomes a resort of bacteria and virus. It's even worse for the keyboard in net pubs or shared offices. With the new invention, due to the portable compact size and full function, the invention has provided a way to personalize the keyboard that can be connected to different computers and screens in various locations. In another word, one can bring his own personalized keyboard to avoid using public keyboards. Another meaning for a personalized keyboard is that one can even chose different keyboard size and style according to the operator's taste and hand size.
8. The invention can also be a hardware integration platform. Within the compact book-shaped body, the keyboard can also be integrated with hand writing panel or small size LCD display screen on (or underneath) the area of key indicia It can be even developed into a palm computer. A picture of the future application is that people may only need to bring his small size ‘back-type-keyboard computer’ during travel and remotely connect to the large screen wherever available.

### BRIEF DESCRIPTION OF THE DRAWINGS

FIG. 1 is the front view of embodiment 1 of the invention. The key 1, 2, 3 and 4 can be configured as different member of Group 3 keys that are further defined in the detailed description.

FIG. 2 is the back view of embodiment 1 of the invention. The key 0, key 5 and 6 can be configured as different member of Group 3 keys that are further defined in the detailed description.

FIG. 3 is the front view of zone partitions of the invention. The Zone 3, Zone 4, Zone 5 areas are shown in different types of shading.

FIG. 4 is the back view of the zone partitions of the invention, The Zone 0, Zone 1, Zone 2 areas are shown in different types of shading.

FIG. 5 shows the Group 1 keys (26 Alphabet keys, all digit and all symbol keys) layout which is the result of QWERTY layout mapping into Zone 0 on the back side of the invented keyboard. The row numbers on the upper part of the drawing show 8 vertical key rows. The horizontal line shows the alignment of the shaded ‘F’ and ‘J’ keys.

FIG. 6 is a revision of the layout shown FIG. 5, a more symmetrical layout of Group 1 keys used on the embodiment 1. The row numbers on the upper part of the drawing show 8 vertical key rows. The horizontal line shows the alignment of the Shaded ‘F’ and ‘J’ Keys.

FIG. 7 shows two examples of key indicia that can be alternatively used on embodiment 1.

### DETAILED DESCRIPTION OF THE INVENTION

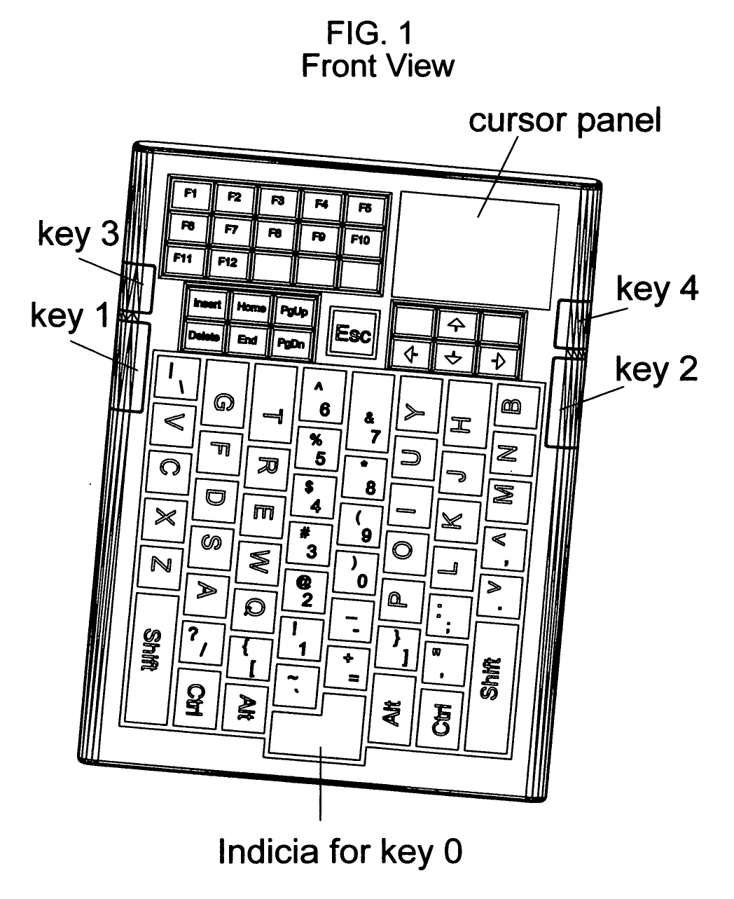

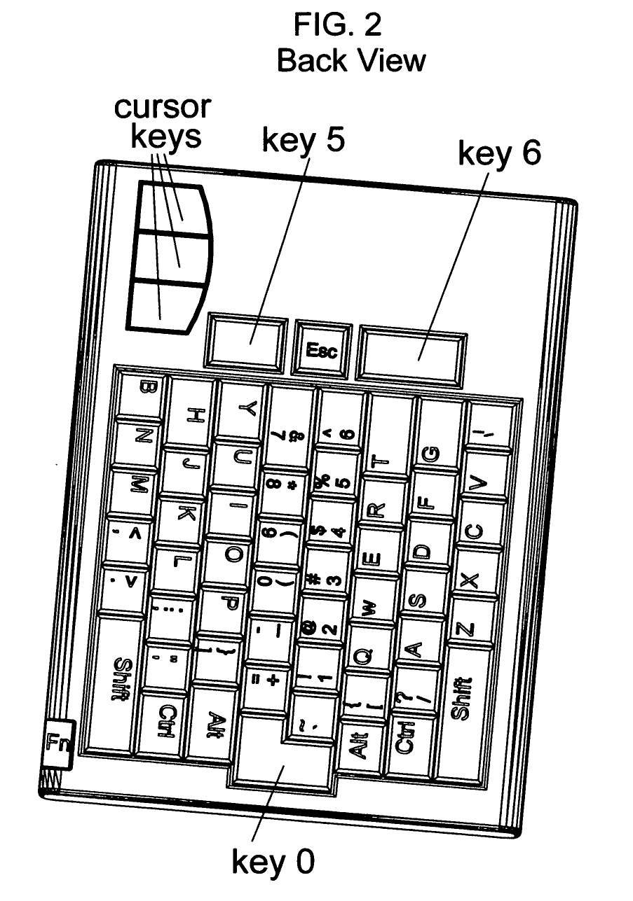

The invention is a computer keyboard or data input device takes the shape of ordinary book or a planer brick, With the new invention, the operator need to type the keys with both hand in the back side for keyboard while locate the keys by looking at the indicia on the frond side of the keyboard. FIG. 1 and FIG. 2 show respectively the front and back view of one recommended embodiment (refer as embodiment 1) of the invention.

1. Key Groups and Zone Partitions

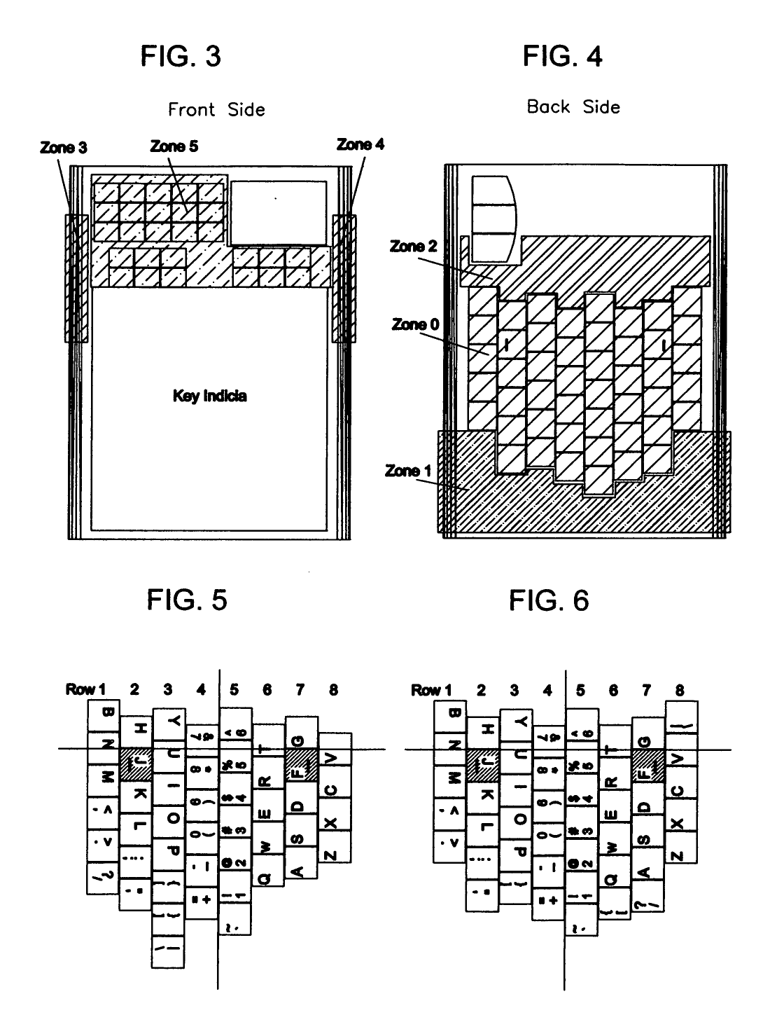

The hand movements around the book-shaped keyboard are very delicate and full of possibilities, especially with two hands operates the keyboard and cooperate with each other. One can emulate the situation by holding a diary note-book. After considering the finger movement on the book-shaped surface during touch typing and the function of all members of the keys, the author has divided all the keys into 3 groups and partitioned the book-shaped keyboard surface with different zones. FIG. 3 and FIG. 4 show the partition of the front side and back side respectively. The Groups and Zones are defined as below.
Group 1 keys include all the 26 alphabet keys, 0 to 9 number keys and all the symbol keys.
Group 2 keys include ‘F1’˜‘F12’ keys, ‘Insert’, ‘Delete’, ‘PgUp’, ‘PgDn’, ‘Home’, ‘End’, arrow keys and other extended function keys.
Group 3 keys include ‘Space’, ‘Backspace,’ ‘Return’, ‘Shift’, ‘Ctrl’, ‘Alt’, ‘Caps lock’, ‘Tab’, ‘Fn’, ‘Esc’ and ‘Delete’. The ‘Delete’ key is included here again is because it has a similar function as ‘Backspace’. The Group 3 keys are all with dedicated key functions and also most frequently used.
Zone 0 is a middle major area of keys on the back side of the keyboard as shown in FIG. 4. Zone 0 is assigned only with all the group 1 keys.
Zone 1 is a lower area of keys on the back side of the keyboard adjacent to Zone 0 as shown in FIG. 4. The boundary between Zone 1 and Zone 0 is flexible depend on the key layout and key shapes of Zone 0. During touch typing, Zone 1 is to be reached by little fingers and ring fingers. Part of Group 3 keys will be allocated into this zone depend on further embodiment choices.
Zone 2 is an upper extended area of keys on the back side of the keyboard adjacent to Zone 0 as shown in FIG. 4. The boundary between Zone 2 and Zone 0 is flexible depend on the key layout and key shape of Zone 0. Compare to the standard keyboard, Zone 2 is a newly extended area. Index finger and middle finger can reach the keys in Zone 2. It is a very convenient zone for touch typing and some frequently used keys can be arranged in this zone. From FIG. 3 and FIG. 4 we can see Zone 2 is behind Zone 5, so the key positions can only be partly shown by the key indicia on the front side. Part of Group 3 keys will be allocated into this zone depend on further embodiment choices.
Zone 3 is an area of keys on the left edge nearby the front side as shown on FIG. 3. To avoid fingering interference during typing, the area is more close to the front side than to the back side. Zone 3 is suitable for touch typing with left thumb. Part of Group 3 keys will be allocated into this zone depend on running embodiment choices.
Zone 4 is an area of keys on the right edge nearby the front side as shown on FIG. 3. To avoid fingering interference during typing, the area is more close to the front side than to the back side. Zone 4 is suitable for touch typing with right thumb. Part of Group 3 keys will be allocated into this zone depend on further embodiment choices.
Zone 5 is an upper area of keys on the front side as shown on FIG. 3. Zone 5 is assigned only with Group 2 keys.
Area of Key indicia, As shown in FIG. 3, the area is on the front side of the invented keyboard and has a print of key indicia corresponding to the keys in Zone 0 and Zone 1 area on the back side of the keyboard. For some of the keys in Zone 2, the indicia can also be available if the key position is not directly behind the keys in Zone 5. As exemplified in Embodiment 1 in FIG. 1 and FIG. 2, the ‘Esc’ key has its indicia on the front side.

The overall structure is that the Zone 0, 1 and 2 forms a keypad on the back side to be operated by fingers except thumbs, while the Zone 3, 4 and 5 forms a keypad on the front side to be operated only by thumbs (thumb pad). The Zone 2 and Zone 0 are not necessarily joint together as shown on FIG. 4, they can be separated from each other depend on choice. The Zone 3, 4 and 5 are not necessarily separated as shown on FIG. 3, the embodiment choice of keys size, key shape and key members might joint them together.

2. Group 1 key layout.

As described above, The Alphabet Keys, Number and Symbol are referred as Group 1 keys and mapped into Zone 0. FIG. 5 shows the initial mapping of the group 1 keys from standard keyboard QWERTY layout onto the said zone 0. The mapping has the following characteristics.
The ‘F’ key and ‘J’ are aligned horizontally as shown on the FIG. 5. This arrangement keeps the ‘home position’ of both right hand and left hand aligned.
The keys are arranged in 8 vertical rows so left hand and right hand each covers 4 rows. The right hand and left hand each covers the same sub-sets of Group 1 keys as they are on the standard QWERTY keyboard.
As a result of the mapping, number 0-9 keys and most of the symbol keys are positioned on the middle rows (row 4 and row 5) of the layout. It practically makes the number and symbol keys more visible to the operator compared to that on a standard keyboard.
The shifts of key positions between the key rows keep the same as that on the standard QWERTY keyboard. The key layout keeps as much as possible the fingering of Group 1 keys.

One can be satisfied with the FIG. 5 layout and continue make key arrangements for other zones of the keyboard to complete the keyboard construction. however, as one very useful variation or embodiment layout of the invention, FIG. 6 gives out an adjusted layout with 4 symbol key i.e. ‘\|’ key, ‘]}’ key, ‘=+’ key and ‘/?’ key are moved to new positions. The new layout has most of the characteristics as FIG. 5 layout. It doesn't incur much fingering change than the standard keyboard but gives out a more symmetric layout and also give way to the better arrangement of Group 3 keys in Zone 1.

Of cause there are other ways to re-position keys to make layout symmetrical. Since we are trying to keep as much as possible the characteristic of the standard keyboard, the number of keys necessary to be repositioned is no more than 5, the useful ways to reallocated them are very limited and the variation will not deviated much from illustrated layout in FIG. 6. We consider these variations as embodiment changes for the invention. After the Group 1 keys are settled, we can go further to the other Zones for Group 2 and Group 3 key arrangement.

3. Group 2 key layout

As described above, page control keys (‘PgUp’, ‘PgDn’, ‘Home’, ‘End’), ‘Insert’, ‘Delete’, ‘F1’˜‘F12’ keys, arrow keys and other extended function keys are defined as Group 2 keys. In many computer keyboards (e.g. portable computer), these keys takes smaller size because it's less likely for the operator to type them in quick multiple combinations. In the invention herein, we also keep Group 2 keys smaller in size than the keys of the other groups.

As shown on the FIG. 3 and FIG. 1, The Group 2 keys are placed in Zone 5 on the front side to be operated by thumbs, the arrow keys can be covered by the right hand thumb and the ‘PgUp’, ‘PgDn’, ‘Home’ and ‘End’ ‘Insert’ and ‘Delete’ keys can be covered by the left hand thumb. The ‘F1’˜‘F12’ keys are placed on the upper left part of Zone 5 (this requires the ‘Fn’ key to be placed on the right hand side on the Zone 1 area). Need to mention that hands need to move out from the said ‘home position’ so the thumbs can reach the group 2 keys. It is possible to make a ‘mirror’ layout arrangement for Group 2 keys for left hand users.

4. Group 3 key layout

As defined above, the Group 3 keys including ‘Space’, ‘Backspace,’ ‘Return’, ‘Shift’, ‘Ctrl’, ‘Alt’, ‘Caps lock’, ‘Tab’, ‘Fn’, ‘Esc’ and ‘Delete’. To include ‘Delete’ key here again is due to it has the function similar to ‘Backspace’. The Group 3 keys are allocated into Zone 1, 2, 3 and 4. They can be allocated in different arrays and combinations into the said 4 zones. The useful combinations and arrays are very limited. Certain preferences can be used to create the useful combinations and arrays. The preferences are out of considerations of the functions of the keys, the typing habits on a standard keyboard and ergonomic considerations. Below list some of the preferences.
Preference 1, ‘Shift’, ‘Control’, ‘Alt’ and ‘Fn’ should be allocated into Zone 1 to be typed by little fingers.
Preference 2, Due to high frequency of been typed ‘Space’ and ‘return’ keys should be placed in the most convenient and comfortable key position of the 4 zones. They can be allocated twice if necessary.
Preference 3, Keys like Tab and Caps Lock are the lest frequent to be used, they can be placed in a relatively less convenient place, that is, hands need to move out of the home position for touch typing.
Preference 4, Keys can be allocated to the position similar to where they are placed in the standard keyboard.

Different allocation of arrays and combinations of Group 3 keys onto the said 4 zones would create different embodiment key layout of the invention. More details please see embodiment descriptions below.

5. Area of key indicia.

As shown on FIG. 3 as well as FIG. 1, the key indicia on the front side of the keyboard show exactly the positions of the keys on back side. Unlike the standard keyboard that lies flat on the table. The invented keyboard stands nearly vertically and the key indicia facing directly to the operators eyesight without been blocked by the operators hand like the way in the standard keyboard.

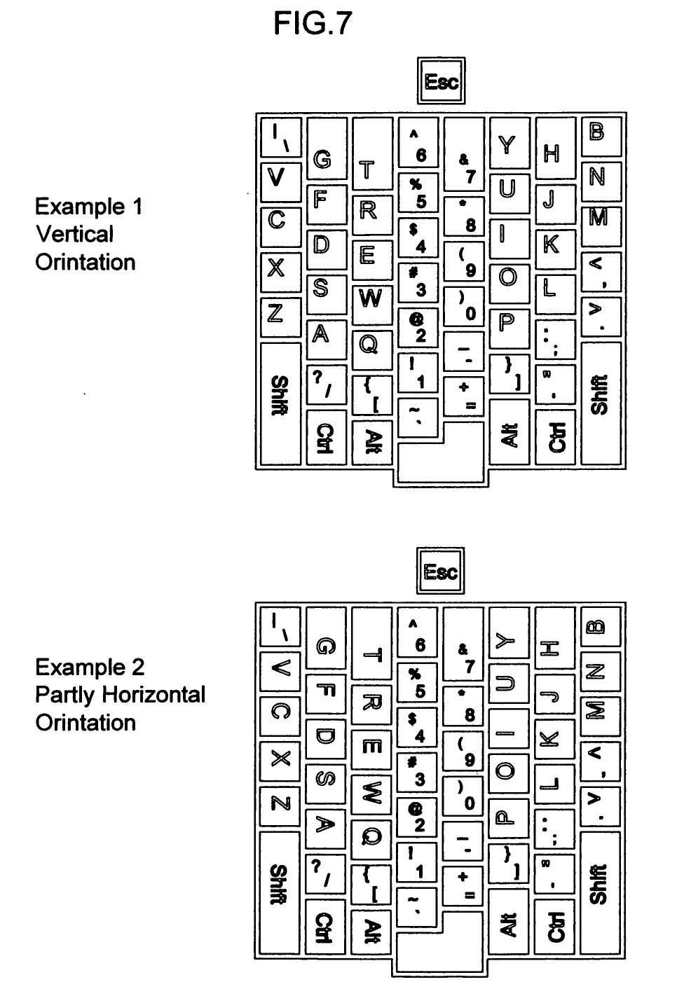

FIG. 7 gives out 2 examples of key indicia that can be alternatively used in Embodiment 1. One can see form both examples that the number/symbol keys now located middle of the middle of the indicia (row 4 and row 5) It is now much easier to identify the positions even than a standard QWERTY keyboard.

The difference between the two examples of key indicia is that the example 1 is with vertical alphabetic letters so they can easily be read by operator while the example 2 place the alphabetic letters horizontally so the operator can easily trace back to the familiar key layout on the back side of the keyboard and recall the fingering for touch typing.

The author would like to point out that there are many simple and apparent mechanisms to illustrate the key positions on the front of the keyboard, such as stickers, dummy keys, LED lights, transparent keyboard body (it can even shows movement when the real keys are pressed), or even by a display screen, they can be regarded as implementation of the said key indicia.

6. Integrated Cursor Tracking Device (Mouse)

It's the purpose of the invention herein to develop a full function data input device that can be carried around and away from the table. The integration of the function of mouse or cursor tracking device is indispensable. As illustrated in the FIG. 1, 2, 3 and 4, cursor penal is positioned on the upper right potion on the front side of the keyboard with the cursor buttons on the corresponding back side of the keyboard. For a left handed operator, the cursor panel (together with its keys) can also be placed on the left side. Accordingly, The ‘F1’˜‘F12’ keys of the Group 2 keys can be moved to right hand side and also ‘Fn’ need to be move the to left hand side to be operated by the little finger of the left hand.

7. Embodiments Description

As stated throughout the description, the invention is very versatile and possible to make different configurations. Different allocation of Group 3 keys into Zone 1 to Zone 4 will give different embodiment. The author has exemplified here a typical embodiment as Embodiment 1 and also discussed some other type of embodiments which have certain advantages and drawbacks.

### Embodiment 1

As shown in FIG. 1 and FIG. 2 (also refers to FIG. 3 and FIG. 4 for partitions), in Embodiment 1, we adapt the established symmetric Group 1 key layout as shown on FIG. 6. As part of the Group 3 keys, the ‘Shift’, ‘Ctrl’ and ‘Alt’ keys are fixed in Zone 1 on both left and right side ‘Fn’ key are also placed in Zone 1 on the right hand edge near the back side of the keyboard.

In Zone 1, 2, 3 and 4 respectively, we leave Key 0, 1, 2, 3, 4, 5 and 6 open for further assignment of the rest of Group 3 keys in different combinations. All these key positions had it's convenience for different typing functions, e.g. the key 1 and key 2 are convenient to be pressed by thumbs, so it is natural to assign them as ‘Space’ as on the standard keyboard. By experiments, the author recommends the following possible assignment without excluding other possible choices.
Key 0 can be assigned as ‘Return’ or ‘Back Space’
Key 1 and key 2 can be assigned as ‘Space’, ‘Backspace’, ‘Return’
Key 3 and Key 4 preferably be assigned as ‘Tab’, ‘Caps lock’, Backspace, Delete
Key 5 and Key 6 can be assigned as ‘Space’, ‘Backspace’ and/or ‘Return’, ‘Delete’, ‘Tab’ or ‘Caps lock’

The most typical assignment suggested below:
Key 0 - - - Return
Key 1 - - - Space
Key 2 - - - Space
Key 3 - - - Tab
Key 4 - - - Caps Lock
Key 5 - - - Back Space
Key 6 - - - Delete

The advantage of the Embodiment 1 is that it keeps a minimum key numbers in Zone 1 so the small fingers will not be over burdened. The keyboard also looks symmetric and keeps a golden section ratio between width and length.

### Embodiment 2

For an extreme case called Embodiment 2 in which one can keep, ‘Return’, ‘Back space’ , ‘Tab’, ‘Caps lock’, ‘Shift’, ‘Ctrl’, ‘Alt’ and ‘Fn’ in Zone 1. In this case, Zone 3, Zone 4 only have ‘Space’ key assigned, Zone 2 may not need to assign any keys. This embodiment is loyal to QWERTY Layout since all these keys are in their traditional place similar as they are in the QWERTY keyboard. And the key positions are easier to be remembered by the operator. The drawback is that the little finger would be too busy and the Zone 1 would be crowded by keys. We exemplify this embodiment only to show that completely loyal to the QWERTY layout may not be a good choice for the book-shaped keyboard.

### Other Embodiments

The similar grouping and partition scheme stated in this article can be applied to Dvorak layout and other prevalent layout of different languages. These would create embodiment of the invention based on different layout or different languages.

It would be lengthy to list all the embodiments. It is possible to make other configurations of the invented keyboard that not obeying any preferences, and there can be some other embodiment that deviates slightly with the grouping and partitions rules introduced hereby. The introduced grouping and partition technique has established a good method to construct the book-shaped keyboard together with its key layout and many embodiments.

8. Size of the keys and dimensions of keyboards

In order to create a more applicable embodiment, we can adapt keys with the same size as they are on a potable computer keyboard. That is, For embodiment 1 shown on FIG. 1 and FIG. 2, with the key size of 18.5×18.5 mm in the back side of the keyboard (some keys need to be longer), and key size of 16.5×12.5 in the front for Group 2 keys in Zone 5, the Embodiment 1 keyboard will be around 240 mm in length and 183 mm in width, just the sizes of B5 paper. It can go down to A4 size and even more compact when uses smaller size keys.

9. Manufacture Details

The keyboard needs to be made rigid and with smooth surface. The edges need to be rounded especially the left and right edges need to be rounded in appropriate radius to fit the hand's grip and moving around. The keyboard also needs to have a cable connection (USB/Serial) or wireless connection (e.g. blue tooth) to computer. Since keys are all around the keyboard surface, means should be implemented to avoid keys to be mistakenly pressed whenever keyboard is in use or lay idle, one way is to make the surface of the keyboard frame higher or equal than the top of the keys.

10. Optionally Integrated Hand Writing Board or LCD Displace Screen

Since the key indicia area in the front side of the keyboard provides a flat and blank area only for showing the positions of the keys. As an option, it is possible for the manufacturer to integrate a hand writing board or a LCD display screen on the key indicia area.

11. Method of Operating the Keyboard.

There are basically three positions to use the keyboard:

1) Place the lower end of the key board on the table or a lower drawer of the table when the operator is sitting straight on a chair.

2) Place the lower end keyboard on the operator's lap while sitting on a chair, sofa or couch.

3) Place the lower end keyboard on the operator's abdomen when the operator is lying on bed.

The keyboard stands vertically or inclined forward so the key picture faces to the operator's eyes. Leaving the keyboard's weight on where it stands, the operator's palms and fingers surround the keyboard loosely. The two palms facing each other, the two index fingers slightly touch the F and J key respectively.

During touch typing, the left and right hands need to help each other in a harmonious way. When one hand is typing, the other hand can grip and help to fix the position of the keyboard or press the combination keys such as ‘shift’ and ‘ctrl’ when necessary. The fingering for typing the Group 1 keys on the invented keyboard is similar to that on a standard computer keyboard. While the fingers typing the Group 1 keys on the back side of the keyboard, the thumbs touch lightly against the keyboard to maintain its position. Thumbs are mostly used to type the group 2 keys and some of the group 3 keys on Zone 3 and Zone 4 and also to operate the cursor tracking panel on the front side of the keyboard. Hands needs to move out of the ‘home position’ when do so.

Need to mention, the invented keyboard can not be operated properly without the lower end of the keyboard being supported by lap or abdomen or a table. In another word, with the book-shaped keyboard stand on a proper supporting place, the operator's hands are not occupied by holding the keyboard thus free enough to do the touch typing.

For the people already familiar with the standard QWERTY keyboard, one could soon gain typing speed again on the book-shaped keyboard since the invention keeps most of the characteristics of the QWERTY layout, It is better to ‘imagine’ the QWERTY layout keys on back side of the keyboard and only look at the indicia when the key positions are forgotten.

1. A computer keyboard system or a data input device comprising:
a stand alone, book-shaped, edge-rounded and substantially rigid structure including a front side that is facing to the operator and a back side that is off sight of the operator.
a keypad on the said back side that are partitioned into 3 adjacent zones including:
Zone 0, a major area of keys on the middle of the keypad.
Zone 1, an area of keys on the lower part of the keypad including right and left edges nearby the said back side.
Zone 2, an area of keys on the upper part of keypad.
a keypad on the said front side that are partitioned into 3 adjacent zones including:
Zone 3, an area of keys on the left edge nearby the said front side.
Zone 4, an area of keys on the right edge nearby the said front side.
Zone 5, an area of keys on the upper part of the said front side.
a scheme to group and allocate the keys into the said zones including:
Group 1 keys, including all the 26 alphabetic keys, all the number keys and all the symbol keys, are placed on the said Zone 0 on the said back side.
Group 2 keys, including ‘F1’˜‘F12’ keys, ‘Insert’, ‘Delete’, ‘PgUp’, ‘PgDn’, ‘Home’, ‘End’, 4 arrow keys and other extended function keys, are placed on the said Zone 5 Area on the said front side.
Group 3 keys, including ‘Space’, ‘Backspace,’ ‘Return (Enter)’, ‘Caps lock’, ‘Tab’, ‘Shift’, ‘Ctrl’, ‘Alt’, ‘Fn’, ‘Esc’ and ‘Delete’ keys, are allocated onto the said Zone 1, Zone 2, Zone 3 and Zone 4 in different arrays and combinations.
an area of key indicia on the said front side corresponding to the said keypad on the said back side.

2. A computer keyboard system as in claim 1, wherein the said Group 1 keys on the said Zone 0 area adapts a layout with eight adjacent vertical rows of keys with the ‘F’ and ‘J’ keys horizontally aligned so the home positions of the right hand and left hand are therefore aligned.

3. A computer keyboard system as in claim 2, wherein, on the said Zone 0 area, the said Group 1 keys adapts a layout with eight adjacent vertical rows of keys which, albeit different from QWERTY keyboard layout, keeps most of the key distributions and key row shifting of the QWERTY keyboard layout.

4. A computer keyboard system as in claim 3, wherein the said Group 1 key layout on the said Zone 0 area are further adjusted to a more symmetric key layout by reallocates no more than 5 symbol keys of the Group 1 keys.

5. A computer keyboard system as in claim 1, wherein the said book shaped body includes an integrated cursor penal or cursor ball on the said front side to be operated by thumb and the cursor buttons on the said back side of the keyboard to be operated by index finger, middle finger and ring finger.

6. The computer keyboard system as in claim 1, wherein the key-position-display function of the said key indicia on the front side of the keyboard are alternatively realized by means of dummy keys, lighted key indicia, stickers, transparent keyboard body or a display screen.

7. A computer keyboard system as in claim 1, wherein, as options, further includes a hand writing input area or a display screen on the same area of the said print of key indicia on the said front side of the keyboard.

8. A computer keyboard system as in claim 1, wherein the said edges are rounded so that hands can hold it and move up, down and around the keyboard smoothly.

9. A computer keyboard system as in claim 8, wherein, on the said rounded edges, further including keys to be operated by thumbs and small fingers.

10. A computer keyboard system as in claim 1, wherein the said front side and back side surfaces of the book-shaped keyboard are either flat or slightly curved.

11. A method of zone partition and key grouping for a book-shaped keyboard set forth in claim 1, which can be further applied to layouts other than QWERTY or to layout of languages other than English.

12. A cursor tracking system or a mouse device stated in claim 5 that can be placed in any device with 2 opposite sides, wherein the cursor penal or cursor ball is placed on one side to be operated by thumb and the cursor buttons are placed on the other side to be operated by index finger, middle finger and ring finger.
